(19) United States
(12) Patent Application Publication
(10) Pub. No.: US 2005/0284368 A1
(43) Pub. Date: Dec. 29, 2005

(54) Apparatus for holding a door to be painted

(76) Inventors: Randall H. Fogg, Benicia, CA (US); Steven T. Tefft, Benicia, CA (US)

Correspondence Address: C. BART SULLIVAN, 1543 SHERMAN DR., BENICIA, CA, 94510, US

(21) Appl. No.: 10/876,381

(22) Filed: Jun. 25, 2004

(51) Int. Cl. B05C 21/00

(52) U.S. Cl. 118/500

(57) ABSTRACT

A method and apparatus to hold a structure such as a door, window frame, shutter and the like is described. In one embodiment, two supporting members are coupled together. The two supporting members may be positioned relative one another to form a rail receiving opening therebetween. The rail receiving opening is configured to receive a rail member therein. In operation, the rail member is attached to the bottom edge of a work piece such as a door, window frame, shutter, etc. and inserted into the rail receiving opening. A closure mechanism is operated by a user thereof to close the rail receiving opening about the rail member to interlock the rail member and the work piece to the apparatus in a processing position. The apparatus may include a transportation carriage configured to allow the apparatus to be rolled across a surface such as a floor. In one configuration, the apparatus includes a handle that is retractable from the apparatus to assist in moving the apparatus. The handle may also be retracted for concealment during a painting process. The handle may be locked in a storage position and used as a carrying handle.

### BACKGROUND OF THE INVENTION

1. Field of the Invention

The present invention relates generally to an apparatus for holding doors, window frames, and the like to be painted.

2. Description of the Related Art

During construction and repair of buildings such as homes, offices, etc. doors, window frames, shutters, and the like are often painted on site to reduce the time required to complete the project. If doors, for example, are not painted first but hung in their respective doorframes and then painted, construction issues may result. For example, if a door is hung in its respective doorframe and then painted, some of the door is covered by the hinges extending therefrom supporting the door to the doorframe. Therefore, those hinge covered portions of the door may be painted incorrectly. While this may provide an easy and efficient way to paint doors, such incorrectly painted areas on such doors may over time be exposed to view and cause the paint job to look unprofessional. Further, a painting process may be delayed as hanging doors by their hinges in existing door frames may not allow portions of the door to be accessible for painting. Additionally, painting structures such as doors, window frames, and shutters, for example, may require painting one side, letting the paint cure, then painting another side, further slowing the painting process and project. Unfortunately, when doors for example are attached to their respective door frames it is possible that during a painting process that paint may be over-sprayed onto other surfaces, such as walls, that are located in proximity of the door being painted. While such over-spray may not cause any harm to adjacent surfaces of new construction, as they may be painted further in the project, paint over-spray may float in the air and coat other surfaces where such paint may contaminate and damage an existing finish. Therefore, it is desirable to detach a structure, such as a door, and separately paint such a structure.

Conventionally, structures such as doors, window frames, and shutters, etc. when painted separately are placed on supporting frames such as sawhorses or conventional frames or stands adapted to hold such structures. Unfortunately, conventional supporting frames and stands impede a flow of paint spray to the structure. For example, a conventional door holder may be used that supports a top and bottom portion of the door being painted to allow the door to be rotated for painting all sides of the door in a painting operation. Such a conventional door holder requires the door be rotated such that a portion of the door being painted is clear of the conventional door holder frame. Further, such conventional stands may directly or indirectly cover a significant area of the door, window frame, or shutter being painted. Thus, such covered areas must be later touched up. To eliminate an over spay condition, structures such as doors, window frames, and shutters may be painted in painting booths located either on the worksite or offsite. Unfortunately, painting booths are generally more expensive to establish and maintain than traditional painting techniques.

Generally, as conventional supporting frames and stands as are often bulky and awkward to store fully assembled, they are often assembled and disassembled for each project. Therefore, while such conventional door holders may offer a more convenient way of holding doors for painting than other traditional methods, the assembly and disassembly of such conventional stands and frames may cause project delays especially if the parts of such conventional stands and frames are misplaced.

To paint more than one door at a time, workers will often place doors such that the surfaces to be painted are about ninety degrees apart. Paint sticks or other door supporting devices are attached to the doors to position them for painting. In this painting configuration, such doors when viewed from above resemble an accordion shape or room divider with each door representing one part of the divider. While such door painting configurations allows many doors to be painted at about the same time, workers must move around the doors to paint the surfaces. Unfortunately, as the doors are positioned adjacent one another, over spray may contaminate surfaces on adjacent doors. Further, if one or more of the paint sticks or door holders fails, the entire door painting configuration could collapse possibly injuring someone.

Therefore, what is needed is a work piece supporting apparatus that provides support for doors, window frames, shutters, and the like that is efficient to store, flexible in operation, provides clear access to a work piece being painted, and is economical to use.

### SUMMARY OF THE INVENTION

An embodiment of the present invention provides an apparatus configured to support a work piece such as a door on a surface such as a floor. The apparatus is configured to engage with a bottom edge portion of the work piece and provide storage for accessories such as tools. The apparatus includes a first work piece supporting member including a first rail engaging lip and a first accessory storage system and a second work piece supporting member having a second rail engaging lip and a second accessory storage system. The apparatus further includes a closure apparatus configured, when operated, to position the first work piece supporting member and the second work piece supporting member relative one another and to position the first rail engaging lip and the second rail engaging lip proximate one another to form a rail receiving opening. The apparatus includes a rail member having external sides configured to cooperate with the first rail engaging lip and the second rail engaging lip. The rail member having at least one door securing mechanism extending therefrom, the at least one door securing mechanism is adapted to secure the bottom edge portion of the door to an upper surface of the rail member. The apparatus further includes at least two coupling members slidably coupling the first work piece supporting member and the second work piece supporting member together and a carriage system disposed on a bottom portion of the first work piece supporting member and the second work piece supporting member. The carriage system is configured to support the first work piece supporting member and the second work piece supporting member such that the apparatus may be moved across the surface. The apparatus includes a retractable handle slidably attached to a side wall portion of the first work piece supporting member and another sidewall portion of the second work piece supporting member. The apparatus includes at least one apparatus interlock system disposed on an upper portion of the first work piece supporting member and on another upper portion of the second work piece supporting member. The at least one interlock system is configured to mate with an interlocking receptacle portion of another of the apparatus to interlock at least two of the apparatuses together.

An embodiment of the present invention provides a work piece supporting apparatus configured to support, on a surface, a work piece, such as a door, from a bottom portion thereof. The apparatus includes a first work piece supporting member slidably coupled to a second work piece supporting member and a first rail member engaging lip disposed on one side of the first work piece supporting member proximate a second rail member engaging lip disposed on a side of the second work piece supporting member. The first rail engaging lip and the second rail engaging lip define a rail receiving opening to receive a work piece support rail therein. The apparatus includes a closure mechanism coupled to the first work piece supporting member and the second work piece supporting member. The closure mechanism when operated is configured to move the first work piece supporting member and the second work piece supporting member relative one another to open and close the rail receiving opening. The apparatus further includes a rail member having a work piece supporting mechanism extending from a top surface thereof to engage with the bottom portion of the work piece. The rail member having mating sides configured to mate with the first rail member engaging lip and the second rail member engaging lip such that when the mating sides are disposed adjacent and about against the first rail member engaging lip, the second rail member engaging lip, and the rail member, the first work piece supporting member, and the second work piece supporting member, and the rail member cooperatively support the work piece. The apparatus includes a transport carriage disposed on each bottom portion of the first work piece supporting member and the second work piece supporting member.

An embodiment of the present invention provides a method for movably supporting a work piece and associated accessories on a surface such as a floor. The method includes providing a first work piece supporting member relative a second work piece supporting member, coupling the first work piece supporting member and the second work piece supporting member together such that the first work piece supporting member and the second work piece supporting member may be positioned relative one another. The method further includes coupling a rail member to a lower edge of the work piece for support thereof. The rail member has one side configured to mate with a first rail engagement lip of the first work piece supporting member and a second side configured to mate with a second rail engagement lip of the second work piece supporting member. The first rail engagement lip and second rail engagement lip form a rail receiving opening disposed between the first work piece supporting member and the second work piece supporting member. The method includes positioning, within a desired alignment position range, the rail member within the rail receiving opening relative the first work piece supporting member and the second work piece supporting member and positioning with a closure means the first work piece supporting member and the second work piece supporting member relative one another to engage with the rail member. The method includes providing a handle means for positioning and carrying the first work piece supporting member and the second work piece supporting member, and providing a transportation means configured to movably support the first work piece supporting member, the second work piece supporting member, the rail member, and the work piece on the surface.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the present invention may admit to other equally effective embodiments.

FIG. 1 is a perspective view of one embodiment of a work piece supporting apparatus in accordance with embodiments of the invention.

FIG. 2 is a bottom perspective view of one embodiment of a work piece supporting apparatus in accordance with embodiments of the invention.

FIG. 3A is a top perspective view of one embodiment of a work piece supporting apparatus in accordance with embodiments of the invention.

FIG. 3B is a bottom perspective view of one embodiment of a work piece supporting apparatus in accordance with embodiments of the invention.

FIG. 3C is a side view of one embodiment of a work piece supporting apparatus in accordance with embodiments of the invention.

FIG. 4A though 4C are perspective views of one embodiment of a rail member in accordance with embodiments of the invention.

FIG. 5A though 5C are segmental views of one embodiment of a rail member in accordance with embodiments of the invention.

FIG. 6A and 6B are perspective views of one embodiment of a hinge covering apparatus in accordance with embodiments of the invention.

FIG. 7 is a perspective view of one embodiment of a doorknob covering apparatus in accordance with embodiments of the invention.

### DETAILED DESCRIPTION OF THE PREFERRED EMBODIMENT

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

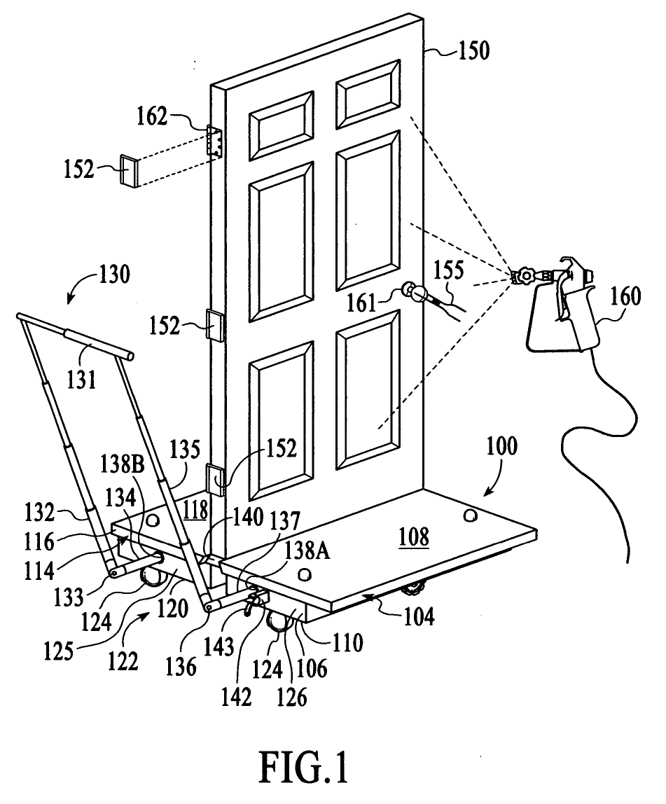

FIG. 1 is a perspective view of one embodiment of a work piece supporting apparatus 100 in accordance with embodiments of the invention. Work piece supporting apparatus 100 includes a first supporting member 104 and a second supporting member 114. First supporting member 104 includes a body portion 106 having an upper surface 108 and a bottom 110. Second supporting member 114 includes a body portion 116 having an upper surface 118 and a bottom 120. First supporting member 104 and second supporting member 114 may be formed of virtually any material configured to support an operation of work piece supporting apparatus 100. For example, first supporting member 104 and second supporting member 114 may be formed of rigid materials such metals, plastics, ceramics, woods, and the like, configured to support an operation of work piece supporting apparatus 100 such as supporting a work piece, such as a door 150, thereon. For purposes of clarity, embodiments of the present invention are described in terms of supporting door 150 to be painted. However, it is contemplated that work piece supporting apparatus 100 may be configured to support one or more of virtually any work piece structure such as door 150, frame, shutter, cabinet, and the like for processing thereof on a surface such as a floor, driveway, sidewalk, ground, field, etc.

First supporting member 104 and second supporting member 114 are slidably coupled such that first supporting member 104 and second supporting member 114 may be adjusted in distance relative one another to couple with a rail member 140. First supporting member 104 and second supporting member 114 may be configured to accept and engage with rail member 140 to form work piece supporting apparatus 100 configured to hold a work piece such as door 150, window, frame, and the like, thereon to be processed, e.g., painted in an about perpendicular position relative upper surfaces 108 and 118. For example, first supporting member 104, second supporting member 114, and rail member 140 cooperate to support a work piece from a bottom portion, e.g., a bottom edge of a door 150, as illustrated in FIG. 1 on a surface such as a floor. Therefore, in a painting operation, work piece supporting apparatus 100 may be positioned about horizontally between door 150, i.e. work piece, and a surface such as a floor, whereas door 150 is positioned about vertically. In such a vertical position, such door 150 may be painted by a painting apparatus 160 such as a paint spay gun, paint can, and the like, from virtually any position, for example, without work piece supporting apparatus 100 blocking paint spray from reaching surfaces of door 150 to be painted. In other words, work piece supporting apparatus 100 may be configured to support a work piece on a surface such as a floor in a processing position configured to allow such a work piece to be painted without moving such work piece or work piece supporting apparatus 100. Therefore, as work piece supporting apparatus 100 provides a processing position that allows clear access to surfaces of work piece to be painted, such a processing position may allow painting personnel to move about and paint such a work piece without a need to move work piece supporting apparatus 100 or work piece.

In one embodiment, work piece supporting apparatus 100 includes a transport carriage 122. Transport carriage 122 may be configured from virtually any type of transportation mechanism that may be used to advantage. For example, transport carriage 122 may include a plurality of wheels 124 rotatably attached to bottom 110 of first supporting member 104 and a plurality of wheels 124 rotatably attached to bottom 120 of second supporting member 114 to allow movement in virtually any horizontal direction relative a surface where such transport carriage 122 is positioned thereon. During a work piece supporting operation, transport carriage 122 may be configured to support a weight of work piece supporting apparatus 100 and door 150 attached thereto, and provides horizontal movement thereof across one or more surfaces such as a floor. In one configuration, a plurality of wheels 124 are configured to retract within respective first supporting member 104 and second supporting member 114. Such a retractable configuration of wheels 124 may allow such wheels 124 to be stored with the first supporting member 104 and second supporting member 114. In another configuration, one or more wheels 124 may be detachable from respective first supporting member 104 and second supporting member 114 to allow for removal and storage for example.

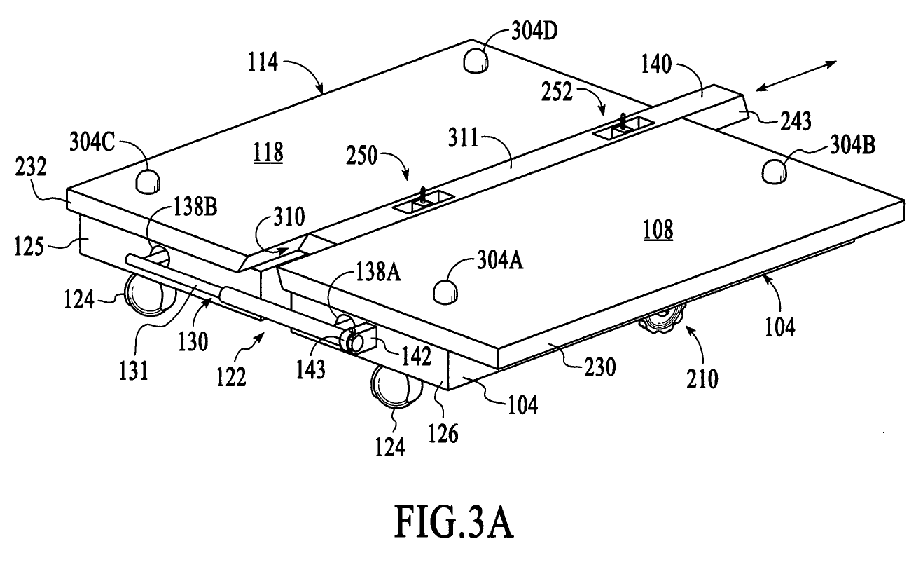

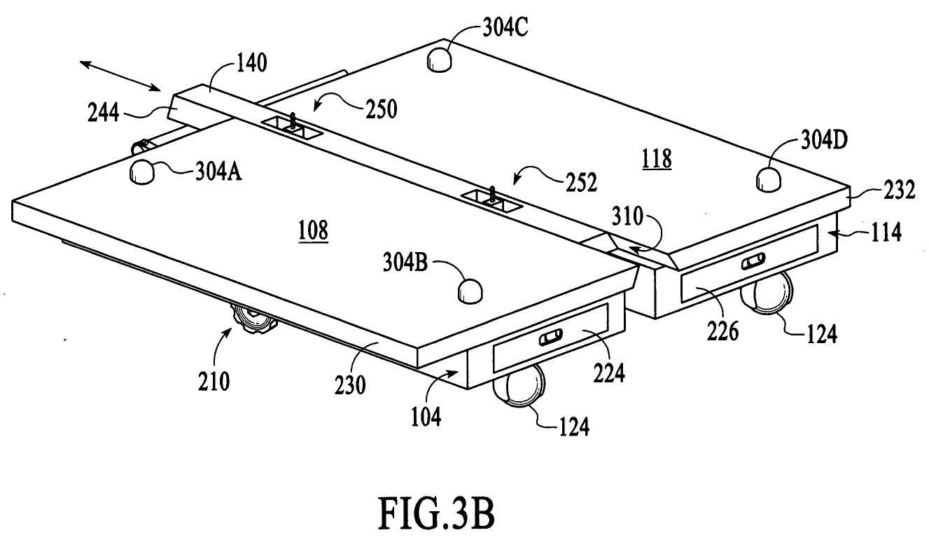

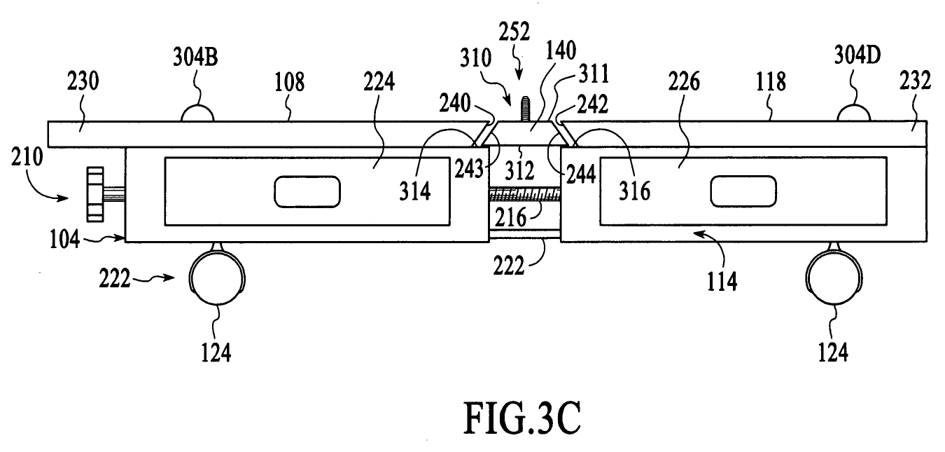

In one embodiment, work piece supporting apparatus 100 may include a handle 130. Handle 130 may be configured to retract inside work piece supporting apparatus 100 for storage and concealment thereof, and used as a carrying handle, as described further below. Handle 130 has a first leg 132 and a second leg 135 that may be formed of a variety of materials such as metal, plastic, wood, cloth, and the like. First leg 132 and second leg 135 are coupled to a handle grip 131 on one end. Handle grip 131 may be formed of virtually any material that may be used to advantage. For example, handle grip 131 may be formed from one or more polymers, leather, cloth, and the like, to provide a grip to a user thereof. In one embodiment, handle grip 131 may be configured to horizontally expand to accommodate relative changes in horizontal spacing between first supporting member 104 and second supporting member 114. For example, handle grip 131 may include two pieces that slide relative one another to allow handle grip 131 to expand or contract horizontally as needed. In one configuration, a handle lock 142 may be used to secure handle in an open or closed position as described further below. Handle lock 142 may include a lock member 143 configured to securely lock handle grip 131 to first supporting member 104 so that handle 130 may be used as a carrying or storage handle when in a retracted position, for example. Handle lock 142 may be virtually any type of locking mechanism such as a latch, combination lock, key lock, snap, and the like. While handle lock 142 is illustrated coupled to first supporting member 104, it is contemplated that handle lock 142 may be positioned on either first or second supporting member 104 and 114, or may be integral to handle 130. First leg 132 may include a first apparatus connection member 134 pivotally attached thereto on one end via joint 133. Second leg 135 may include a second apparatus connection member 137 pivotally attached thereto on one end via a joint 136. In one operation, handle 130 may be tilted via joints 133 and 136 to position grip 131 at a desired height for a user thereof. In one embodiment, handle 130 may be collapsed in a telescoping fashion for storage thereof. For example, once collapsed, first leg 132 and connection member 134 may be inserted into a leg receiving opening 138B extending into a sidewall 125 of body 116. Similarly, once collapsed, second leg 135 and connection member 137 may be inserted into leg receiving opening 138A extending into a sidewall 126 of body 106 (See FIG. 3A below).

During a work piece process operation such as painting, it may be desirable to cover work piece parts not intended to be processed. For example, door 150 may include a doorknob 161 and a portion of hinge hardware 162 attached thereto. Work piece supporting apparatus 100 may store one or more hinge covers 152 and doorknob cover 155 described further below.

In summary, a work piece supporting apparatus 100 may be configured to movably support a work piece such as a door 150 extending upwardly therefrom on a surface such as a floor. A rail member 140 may be supported between a first supporting member 104 and a second supporting member 114. Thus, rail member 140, first supporting member 104 and second supporting member 114 cooperate to support such a work piece, e.g., a door 150, attached thereto on such surface. Work piece supporting apparatus 100 may be configured to be moved across a horizontal surface, e.g., floor, via transportation carriage 122. Work piece supporting apparatus 100 may include handle 130 configured to allow an operator thereof to position work piece supporting apparatus 100 on such a surface.

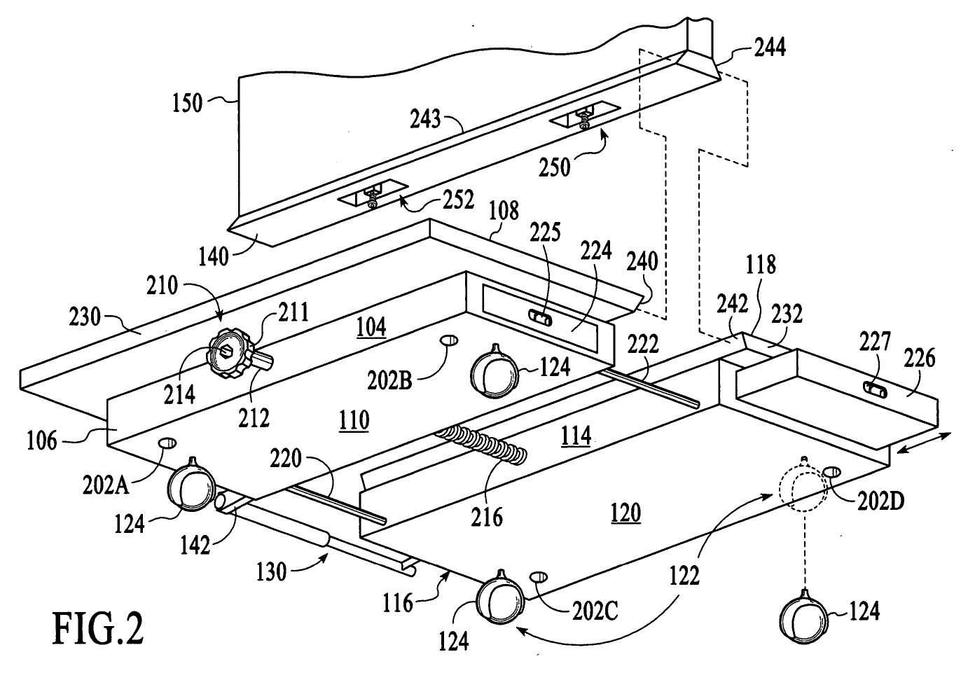

FIG. 2 is a bottom perspective view of one embodiment of work piece supporting apparatus 100 in accordance with embodiments of the invention. FIG. 3A is a top perspective view, FIG. 3B is a bottom perspective view, and FIG. 3C is a side view of one embodiment of work piece supporting apparatus 100 in accordance with embodiments of the invention. First supporting member 104 and second supporting member 114 are slidably coupled via a coupling member 220 and a coupling member 222. Coupling members 222 and 220 may be formed from virtually any materials and structures that may be used to advantage to align and slidably couple first supporting member 104 and second supporting member 114 together. For example, coupling members 222 and 220 may be formed from shafts of rigid materials such as wood, metal, plastic and the like, configured to support positioning first supporting member 104 and second supporting member 114 relative one another.

Work piece supporting apparatus 100 includes a closure apparatus 210. Closure apparatus 210, when operated, positions first supporting member 104 and second supporting member 114 relative one another along a longitudinal axis of coupling members 222 and 220. Closure apparatus 210 includes a knob 211 attached on one end of a shaft 212. Knob 211 may include a turning tool orifice 214 that may be used to turn closure apparatus 210. Turning tool orifice 214 may be configured to accept therein at least one type of tool such as a hex wrench, screwdriver, socket wrench, and the like. In one embodiment, shaft 212 includes a screw end 216. Screw end 216 extends through first supporting member 104 and second supporting member 114. Screw end 216, when operated, is configured to cooperate with first supporting member 104 and second supporting member 114 to position first supporting member 104, and second supporting member 114 relative one another. For example, consider the case where screw end 216 when rotated in a clockwise direction relative a longitudinal axis of shaft 212, draws first supporting member 104 and second supporting member 114 together and when rotated in a counter clockwise direction, screw end 216 urges first supporting member 104 and second supporting member 114 apart. While for clarity, a closure apparatus 210 having a screw end 216 is described herein, it is contemplated that virtually any closure mechanism configured to position first supporting member 104 and second supporting member 114 relative may be employed such as a pulley system, for example.

In one embodiment, first supporting member 104 includes a first drawer 224 configured to store items such as painting accessories therein. First drawer 224 has at least one recessed handle 225 configured such that an operator thereof may pull the drawer 224 out from a side of first supporting member 104. Second supporting member 104 includes a second drawer 226 configured to store items such as painting accessories, construction supplies, tools, and the like. Second drawer 226 may have at least one recessed handle 227 configured such than an operator thereof may pull drawer 227 out from a side of second supporting member 114. While, for clarity first drawer 224 and second drawer 226 are described as pull out drawers 224,226, it is contemplated that first supporting member 104 and second supporting member 114 may include virtually any number and type of storage systems or compartments such as drawers 224,226, bins, slots, racks, and the like. Such storage compartments may be configured to store items such as painting accessories, construction supplies, tools, and the like. Such storage compartments may also be configured to store wheels 124, hinge covers 152, doorknob cover 155, and the like.

In one embodiment, work piece supporting apparatus 100 may be configured to be coupled to other work piece supporting apparatuses 100. For example, two or more work piece supporting apparatuses 100 may be coupled together, e.g., stacked together, for convenient storage and transportation. In one configuration, first supporting member 104 includes one or more interlocking apertures 202A and 202B. Interlocking apertures 202A and 202B may be configured to interlock with a respective interlocking nub 304A and 304B (see FIG. 3). Second supporting member 114 includes one or more interlocking apertures 202C and 202D. Interlocking apertures 202C and 202D may be configured to interlock with a respective interlocking nub 304C and 304D. Virtually any type of interlocking nub 304A-C and respective interlocking aperture 202A-C may be used. For example, such interlocking nub 304A-C may mate together without a locking mechanism or may include a snap lock configuration (not shown) configured such that two or more door holding apparatuses 100 may be snapped together.

In one configuration, first supporting member 104 includes a lip 230 disposed adjacent top surface 108. Lip 230 extends about body 106 sufficiently to protect closure apparatus 210 from contamination from processing materials such as paint. Lip 230 also extends laterally from body 106 to protect drawer 224 from paint or other process liquid used in the processing of door 150. Second supporting member 114 includes a lip 232 disposed adjacent top surface 118. Lip 232 extends laterally from body 116 to protect drawer 226 from paint or other process liquid used in the processing of door 150. Lip 230 may extend about body 106 and lip 232 may extend about body 116 to cover portions of handle 130 such as grip 131 and handle lock 142. For example, when handle 130 is retracted it may be partially covered by lip 230 and lip 232.

First supporting member 104 includes a rail engaging lip 240 disposed adjacent top surface 108 and coextensive to lip 230. Second supporting member 114 includes a rail engaging lip 242 disposed adjacent top surface 118 and coextensive to lip 232. Rail engaging lip 240 and rail engaging lip 242 are disposed distally from one another to form a rail receiving opening 310 (See FIGS. 3B-C). In one operation, rail member 140 includes a first rail engagement edge 243 and a second rail engagement edge 244. Rail member 140 may be disposed within rail receiving opening 310 such that first rail engagement edge 243 is positioned proximate and coextensive with rail engaging lip 240 and second rail engaging edge 244 is proximate and coextensive with rail engaging lip 242. Once a user positions rail member 140 to a desired position relative first support member 104 and second support member 114, closure apparatus 210 may be operated to clamp rail member 140 within rail member receiving opening 310 between first rail engagement lip 240 and second rail engagement lip 242. In one configuration, rail member 140 may be positioned as desired by a user thereof to help center an asymmetrical work piece over work piece supporting apparatus 100 as desired. For more symmetrical work pieces, it is contemplated that a stop (not shown) may be used to help a user thereof center rail member 140 longitudinally with respect to first support member 104 and second support member 114.

In one embodiment, rail engaging lip 240 and rail engaging lip 242 may be angled, e.g., beveled, canted, sloped, etc., with respect to an angle of mating rail engagement edge 243 and 244. In one embodiment, such an angle of mating rail engagement edge 243 and 244 provides a narrow upper portion 311 of rail member 140 and a relatively wider lower portion 312 to resist rail member 140 from being removed upwardly from door holding apparatus 100 or rotated once positioned within rail receiving opening 310 and in contact with rail engaging lip 240 and rail engaging lip 242. In one configuration, body 106 and body 116 extend underneath lower portion 312 to form a shelf 314 and 316 respectively therefore. Shelf 314 and shelf 316 are configured to support rail member 140 and door 150 attached thereto on a lower portion 312. While rail member 140 is described having an angled first rail engagement edge 243 and an angled second rail engagement edge 244, other types of engagement edges 243 and 244 are contemplated that provide a similar function. For example, first rail engagement edge 243 and a second rail engagement edge 244 may be include a plurality of edge configurations such as a saw tooth shape, rounded, hexagonal, and the like.

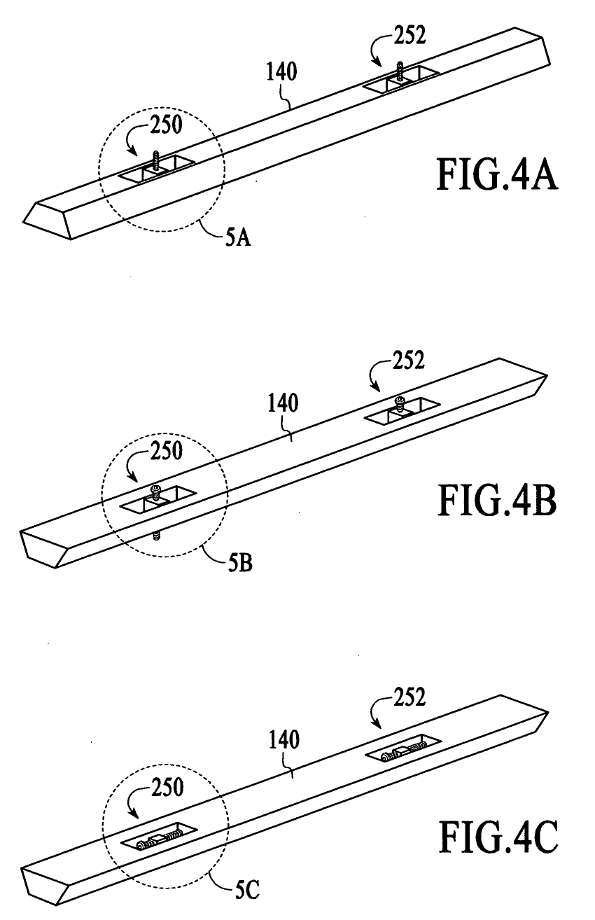

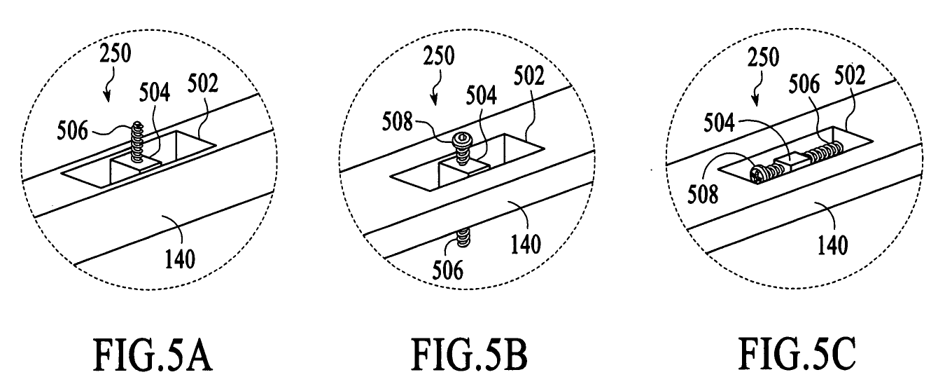

FIG. 4A though 4C are perspective views of one embodiment of a rail member 140 in accordance with embodiments of the invention. FIG. 5A though 5C are segmental views of one embodiment of a rail member 140 in accordance with embodiments of the invention. Rail member 140 includes at least one door securing mechanism 250 disposed within a rail aperture 502. In one configuration, for additional work piece stability a second door securing mechanism 252 may be used. Door securing mechanisms 250 and 252 may be configured to mate with an access support orifice (not shown) provided, for example, by a user thereof to the bottom edge of door 150. For example, a user may drill such an access support orifice into a bottom portion of a door 150. In one embodiment, door securing mechanisms 250 and 252 may include a rotatable body 504 rotatably disposed inside rail aperture 502 extending though rail member 140. Door securing mechanisms 250 and 252 may include a door engagement screw 506 having a head 508. Door engagement screw 506 may be configured to couple with a bottom portion of door 150 using, for example, an access support orifice. Head 508 may be configured to be operated by virtually any tool such as a screwdriver, hexagonal tool, and the like. In one operation, to mate door 150 with rail member 140, door engagement screw 506 is screwed into an access support orifice using head 508 and a tool such as a screwdriver. To allow for storage and concealment, door securing mechanisms 250 and 252 may be rotated such that rotatable body 504 and door engagement screw 506 may be positioned within rail aperture 502. For clarity, door securing mechanisms 250 and 252 are described in terms of using screw type fasteners such as door engagement screw 506 to couple rail member 140 to a bottom portion of door 150, i.e., work piece, however, other types of clamping systems are contemplated. For example, it is contemplated that virtually any fastening system that couples rail member 140 to a bottom portion of door 150 may be used. For example, door securing mechanisms 250 and 252 may use other types of fastening systems and fasteners such as nails, clamp, clip, Velcro type materials, bonding agents, and the like, configured to fasten rail member 140 to a bottom portion of door 150.

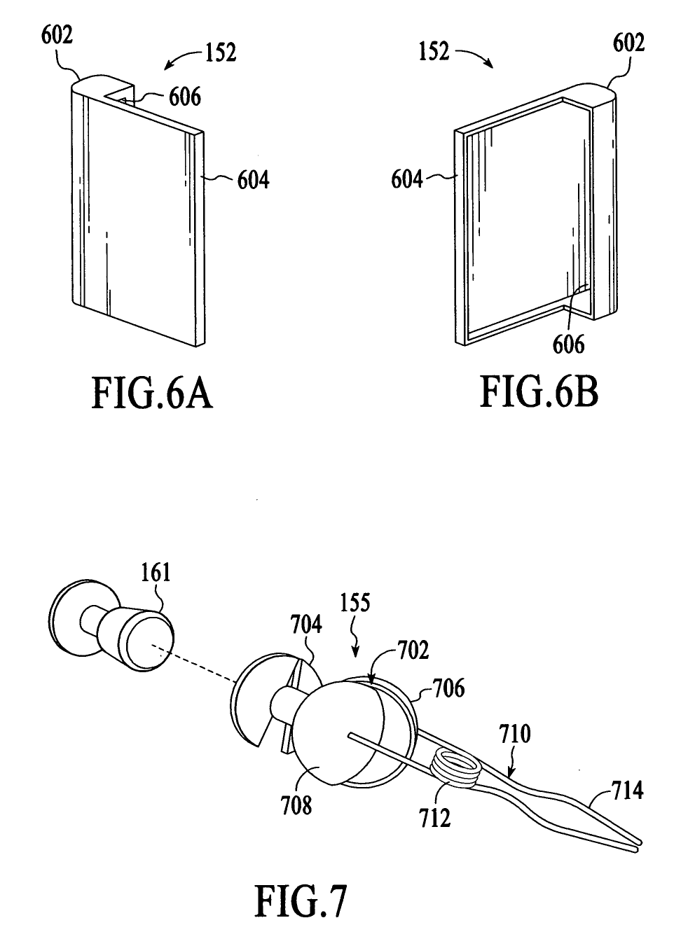

FIG. 6A and 6B are perspective views of one embodiment of a hinge covering apparatus 152 in accordance with embodiments of the invention. In one embodiment, apparatus 100 includes one or more hinge paint covering apparatus 152 to cover and protect hinge hardware 162 from processing liquids and materials such as paint. Hinge covering apparatus 152 includes a hinge cover 602 configured to cover over hinge hardware 162 extending from door 150 and a plate 604 configured to cover over hinge hardware 162 disposed on the door 150. In one configuration, hinge cover 602 includes a hinge cover flange 606 configured to cover over flanges of hinge hardware 162 to protect such flanges from processing liquids and materials such as paint.

FIG. 7 is a perspective view of one embodiment of a doorknob covering apparatus 155 in accordance with embodiments of the invention. Doorknob covering apparatus 155 includes a split cover shell 702 having a first half door covering shell 706 and a second half door covering shell 708. First half door covering shell 706 and second half door covering shell 708 cooperate in operation to cover a doorknob 161 from processing fluids such as paint. Split cover shell 702 is coupled to a spring handle 710. Spring handle includes a spring portion 712 coupled to a handle 714 configured for operation thereof. For example, handle 714 may be configured to spread split cover shell 702 apart to allow a doorknob 161 to be covered thereby. Doorknob covering apparatus 155 also includes a doorknob bezel cover 704. Doorknob bezel cover 704 may be configured to cover other parts of the doorknob 161 as desired from processing liquids such as paint.

While the foregoing is directed to embodiments of the present invention, other and further embodiments of the invention may be devised without departing from the basic scope thereof, and the scope thereof is determined by the claims that follow.

1. An apparatus configured to support a work piece such as a door on a surface such as a floor, the apparatus configured to engage with a bottom edge portion of the work piece and provide storage for accessories such as tools, the apparatus comprising:
a first work piece supporting member including a first rail engaging lip and a first accessory storage system;
a second work piece supporting member having a second rail engaging lip and a second accessory storage system;
a closure apparatus configured, when operated, to position the first work piece supporting member and second work piece supporting member relative one another to position the first rail engaging lip and second rail engaging lip proximate one another to form a rail receiving opening;
a rail member having external sides configured to cooperate with the first rail engaging lip and the second rail engaging lip, the rail member having at least one door securing mechanism extending therefrom, the at least one door securing mechanism is adapted to secure the bottom edge portion of the door to an upper surface of the rail member;
at least two coupling members slidably coupling the first work piece supporting member and the second work piece supporting member together;
a carriage system disposed on a bottom portion of the first work piece supporting member and the second work piece supporting member, the carriage system configured to support the first work piece supporting member and the work piece supporting member such that the apparatus may be moved across the surface;
a retractable handle slidably attached to a sidewall portion of the first work piece supporting member and another sidewall portion of the second work piece supporting member;
at least one apparatus interlock system disposed on an upper portion of the first work piece supporting member and the second work piece supporting member, the at least one interlock system configured to mate with an interlocking receptacle portion of another of the apparatus to interlock at least two of the apparatuses together.

2. The apparatus of claim 1, wherein the first work piece supporting member comprises a covering lip configured to shield a lower portion of the first work piece supporting member from a process liquids applied to the door during door processing.

3. The apparatus claim 1, wherein the second work piece supporting member comprises a covering lip configured to shield a lower portion of the second work piece supporting member from process liquids applied to the door during door processing.

4. The apparatus claim 1, wherein the first accessory storage system and second accessory storage systems each comprise at least one accessory receptacle.

5. The apparatus claim 1, wherein the carriage system comprises a plurality of wheels.

6. The apparatus claim 1, wherein the rail member comprises two angled surfaces extending lengthwise that are configured to mate with a respective one of the first rail engaging lip and the second rail engaging lip.

7. A work piece supporting apparatus configured to support, on a surface, a work piece, such as a door, from a bottom portion of the work piece, the apparatus comprising:
a first work piece supporting member slidably coupled to a second work piece supporting member;
a first rail member engaging lip disposed on one side of the first work piece supporting member proximate a second rail member engaging lip disposed on a side of the second work piece supporting member, the first rail engaging lip and the second rail engaging lip define a rail receiving opening to receive a work piece support rail therein;
a closure mechanism coupled to the first work piece supporting member and the second work piece supporting member, the closure mechanism when operated is configured to move the first work piece supporting member and second work piece supporting member relative one another to open and close the rail receiving opening;
a rail member having a work piece supporting mechanism extending from a top surface thereof to engage with the bottom portion of the work piece, the rail member having mating sides configured to mate with the first rail member engaging lip and the second rail member engaging lip such that when the mating sides are disposed adjacent and about against the first rail member engaging lip, the second rail member engaging lip, and the rail member, the first work piece supporting member, and the second work piece supporting member, and the rail member cooperatively support the work piece; and
a transport carriage disposed on each bottom portion of the first work piece supporting member and the second work piece supporting member.

8. The apparatus of claim 7, wherein the first work piece supporting member comprises at least one storage drawer.

9. The apparatus of claim 7, wherein second work piece supporting member comprises at least one storage drawer.

10. The apparatus of claim 7, wherein the closure mechanism comprises a screw shaft extending between the first work piece supporting member and the second work piece supporting member, the screw shaft having a knob on one end for operation thereof.

11. The apparatus of claim 10, wherein the knob comprises a turning tool orifice disposed therein.

12. The apparatus of claim 7, further comprising a retractable handle configured to telescope between a storage position within the apparatus and an extended position extending therefrom.

13. The apparatus of claim 12, wherein the retractable handle comprises a first leg having one end that is in slidable engagement with a handle receiving orifice extending into the first work piece supporting member.

14. The apparatus of claim 12, wherein the retractable handle comprises a second leg having one end that is in slidable engagement with a handle receiving orifice extending into the second work piece supporting member.

15. A method for movably supporting a work piece and associated accessories on a surface such as a floor, the method comprising:
providing a first work piece supporting member relative a second work piece supporting member;
coupling the first work piece supporting member and the second work piece supporting member together such that the first work piece supporting member and the second work piece supporting member may be positioned relative one another;
coupling a rail member to a lower edge of the work piece for support thereof, the rail member having one side configured to mate with a first rail engagement lip of the first work piece supporting member and a second side configured to mate with a second rail engagement lip of the second work piece supporting member, the first rail engagement lip and second rail engagement lip forming a rail receiving opening disposed between the first work piece supporting member and the second work piece supporting member;
positioning, within a desired alignment position range, the rail member within the rail receiving opening relative the first work piece supporting member and second work piece supporting member;
positioning with a closure means the first work piece supporting member and second work piece supporting member relative one another to engage with the rail member;
providing a handle means for positioning and carrying the first work piece supporting member and second work piece supporting member; and
providing a transportation means configured to movably support the first work piece supporting member, the second work piece supporting member, the rail member, and the work piece on the surface.

16. The method of claim 15, further comprising providing a storage means for storing the associated accessories within the first work piece supporting member.

17. The method of claim 15, further comprising providing a storage means for storing the associated accessories within the second work piece supporting member.

18. The method of claim 15, further comprising providing the rail member with a least one work piece securing means for securing a lower edge of the work piece to the rail member.

19. The method of claim 15, further comprising providing a work piece hardware cover means.

20. The method of claim 16, wherein the work piece hardware cover means comprises a doorknob cover apparatus, a hinge cover, and combinations thereof.
